(19) United States
(12) Patent Application Publication
(10) Pub. No.: US 2014/0104231 A1
(43) Pub. Date: Apr. 17, 2014

(54) Capacitive Touch Panel and the Sensing Method Thereof

(71) Applicant: Touchplus Information Corp., New Taipei City (TW)

(72) Inventor: Shih Hsien Hu, New Taipei City (TW)

(73) Assignee: Touchplus Information Corp., New Taipei City (TW)

(21) Appl. No.: 14/054,331

(22) Filed: Oct. 15, 2013

(30) Foreign Application Priority Data
Oct. 16, 2012 (TW) 101138099

(51) Int. Cl. G06F 3/044

(52) U.S. Cl. CPC G06F 3/044
USPC 345/174

(57) ABSTRACT

The invention discloses a capacitive touch panel, comprising: a comparator receiving a sense signal of a sense path and a reference signal of a reference path at a first input and a second input of the comparator, respectively; a transparent electrode coupled to the sense path and the reference path; a variable transfer capacitance connected to the first input or the second input of the comparator; and a control unit connected to an output of the comparator.

### FIELD OF THE INVENTION

The present invention relates to a touch panel, and more particularly to a capacitive touch panel and the sensing method thereof.

### BACKGROUND OF THE INVENTION

Based on the fact of that the 3C products are rising and developing, continuously. The input devices such as keyboard or mouse of these consumer products are replaced by the touch panel gradually. The touch panel technology provides a friendly interface to allow a user may operate a computer or electronic products more convenient and easier than ever. Touch panels are input devices for operating an apparatus by directly touching a display screen of a liquid crystal display device or the like with a finger, a purpose-built stylus or the like, and include a display which displays operation details and the like, and a detection means which detects the position (coordinates) of a portion of the display screen of the display touched with the finger or the like. Information about the touched position detected by the detection means is sent in the form of a signal to the apparatus, which in turn performs an operation and the like displayed on the touched position. Examples of the apparatus employing such a touch panel include ATMs in banking facilities, ticket vending machines in stations, portable game machines, and the like.

Additionally, the applications of the touch panels are widely spread, the field of such devices includes but not limited to portable communication or information devices (such as personal digital assistant, PDA), electronic dictionaries, handsets, MP3s, digital players, or global positioning systems (GPSs), or other small size electronic devices, financial/commercial system, hospital register system, monitoring and control system, information system and computer assisted instruction system, etc. The convenience of operation is upgrade owing to it's friendly operation interface.

The above mentioned application usually utilizes single-touch panel or writing pad as an input device. However, the single-touch panel or writing pad only can detect a single touch-point at one time. In other words, it merely can receive or process an identification position of the touch signal at each time.

U.S. Pat. No. 4,233,522 has disclosed a capacitive touch panel comprising an array of touch sensitive switch cells. Each switch cell includes a first and a second pair of series connected capacitors energized by a common signal source, the array of switch cells being arranged so that the first pair of capacitors are connected in first groups of switch cells, such as rows, to a corresponding first plurality of signal detectors, and the second pair of capacitors are connected in second groups of switch cells, such as columns, to a corresponding second plurality of signal detectors, the junctions of each pair of capacitors of a single switch cell being selectively coupled to ground by the body or other touch capacitive means for actuating a selected switch cell.

In order to detect the location where a finger or a stylus touches the touch panel, a variety of capacitive touch panel techniques are developed. An example is U.S. Pat. No. 6,970,160, which discloses a lattice touch-sensing system for detecting a position of a touch on a touch-sensitive surface. The lattice touch-sensing system may include two capacitive sensing layers, separated by an insulating material, where each layer consists of substantially parallel conducting elements, and the conducting elements of the two sensing layers are substantially orthogonal to each other. Each element may comprise a series of diamond shaped patches that are connected together with narrow conductive rectangular strips. Each conducting element of a given sensing layer is electrically connected at one or both ends to a lead line of a corresponding set of lead lines. A control circuit may also be included to provide an excitation signal to both sets of conducting elements through the corresponding sets of lead lines, to receive sensing signals generated by sensor elements when a touch on the surface occurs, and to determine a position of the touch based on the position of the affected bars in each layer.

U.S. Pat. No. 7,030,860 has disclosed a transparent, capacitive sensing system particularly well suited for input to electronic devices. The capacitive sensor can further be used as an input device for a graphical user interface, especially if overlaid on top of a display device like an LCD screen to sense finger position and contact area over the display. Furthermore, International Publication Number WO 2009/090534 A2 has disclosed “Device for quantifying an electric unbalance and touch detection system incorporating it”; and U.S. Pat. No. 8,144,132 B2 has disclosed “Multipoint sensing method for capacitive touch panel”.

Due to the aforementioned weakness, a novel capacitive touch panel is provided.

### SUMMARY OF THE INVENTION

In view of foregoing, the present invention discloses a scheme and sensing method for the capacitive touch panel with a simplified sensing circuit and the control unit.

Another objective of the present invention is to use the noise signal carried on the touch signal to judge the strength or the intensity of the touch signal on the capacitive touch panel.

In order to achieve the above object, the invention discloses a capacitive touch panel, comprising: a comparator receiving a sense signal of a sense path and a reference signal of a reference path at a first input and a second input of the comparator, respectively; a transparent electrode coupled to the sense path and the reference path; a variable transfer capacitance connected to the first input or the second input of the comparator; and a control unit connected to an output of the comparator.

The capacitive touch panel further comprises at least one electrode with a first capacitance coupled to the sense path and a vertical line, and a second capacitance coupled to the reference path and the vertical line; a third capacitance coupled to the sense path and grounded, and a fourth capacitance coupled to the reference path and grounded; a fifth capacitance coupled to the sense path and the reference path; a sixth capacitance under the reference path and grounded in the vertical line.

The variable transfer capacitance is controlled by a digital command produced by the control unit. A first input of said sense path is applied on a negative terminal of the comparator, and a second input of the reference path is applied on a positive terminal of the comparator. The output from the comparator is based on inputs of the transparent electrode. A first output of the comparator is 1 if a reference signal through the reference path is higher than that of a sense signal through the sense path, and a second output of the comparator is 0 if the reference signal is smaller than that of the sense signal. A noise possibility is transferred to a noise count after performing a sampling process when touching the sense path, wherein the noise count is set as a switching threshold value for an identification of the touching, and a circuit sensitivity for the touching signal can be adjusted when a reference level without touching and the switching threshold value are adjusted.

According to an aspect of the present invention, the capacitive touch panel further comprising a plurality of comparators to detect sense signals of the sense path at the same time.

According to another aspect of the present invention, it discloses a touch-sensing circuit comprising the above-mentioned comparator, the variable transfer capacitance and the control unit.

A detailed description is given in the following embodiments and with reference to the accompanying drawings and claims.

### BRIEF DESCRIPTION OF THE DRAWINGS

FIG. 1A illustrates a double-side ITO bar type capacitive touch sensor.

FIG. 1B illustrates a signal-side ITO diamond type capacitive touch sensor.

FIG. 2 illustrates a capacitance scheme of matrix electrodes.

FIG. 3 illustrates a simplified electrodes sensing model.

FIG. 4 illustrates a timing diagram of the electrodes sensing model.

FIG. 5 illustrates a charge time with different capacitances.

FIG. 6 illustrates the sense signal and the reference signal after stimulating.

FIG. 7 illustrates the sense signal and the reference signal after touching under stimulus.

FIG. 8 illustrates an electrode sensing scheme according to one embodiment of the present invention.

FIG. 9 illustrates a comparator behavior based on the electrode inputs.

FIG. 10 illustrates signals with incorporated noise.

FIG. 11 illustrates signals with finger touch and incorporated noise.

FIG. 12 illustrates a normal distribution for the noise model.

FIG. 13 illustrates a reference value and a switching threshold value.

FIG. 14 illustrates a group sensing scheme.

FIG. 15 illustrates a noise impact from the group sensing scheme.

### DETAILED DESCRIPTION OF THE PREFERRED EMBODIMENT

The invention hereinafter will be described in greater detail with preferred embodiments of the invention and accompanying illustrations. Nevertheless, it should be recognized that the preferred embodiments of the invention are not provided to limit the invention but to illustrate it. The present invention can be practiced not only in the preferred embodiments herein mentioned, but also in a wide range of other embodiments besides those explicitly described. Further, the scope of the present invention is expressly not limited to any particular embodiments except what is specified in the appended Claims.

This present invention relates to the scheme and sensing method on a capacitive touch panel. The strength or the intensity of the sensed signal is determined by the noise over the sensed signal. The capacitive touch panel using this sensing method is targeted to be used as part of the systems, e.g. smart phones, tablets, PC peripherals, points of sales. One of the essential component of the capacitive touch panel normally is the transparent electrodes formed on the panel. The material for the transparent electrodes is typically an Indium Tin Oxide (ITO). The ITO electrodes (patterns) are either etched or imprinted on a substrate, such as a glass, a film or even PET, PPMA etc. The ITO electrodes are arranged or patterned below in a way to get the optimized performance. The sensing method is surely under the consideration.

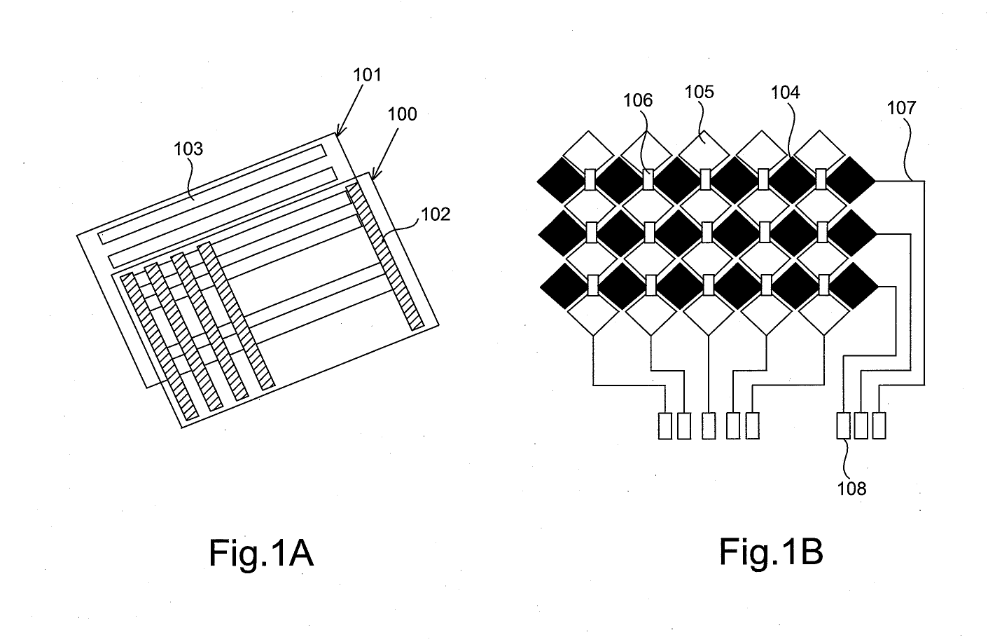

Referring to FIG. 1A, it shows a double-side ITO bar type capacitive touch sensor. The capacitive touch sensor is used for a touch panel device, for example a portable electronic device including a tablet, a personal digital assistant (PDA), a cellular phone, a smart phone, etc. The capacitive touch sensor includes a top layer 100 and a bottom layer 101. The top layer 100 includes multiple touch sensor patterns 102 formed on a top substrate (or film), and the bottom layer 101 includes multiple touch sensor patterns 103 formed on a bottom substrate (or film). The multiple touch sensor patterns 102 and 103 are a touch-sensing layer, which may be formed by an indium tin oxide (ITO) layer or an inductive electrode layer to form multiple inductive electrode patterns. The touch sensor patterns may be formed by a photolithography and etching process, or a printing process. The multiple touch sensor patterns 102 and 103 are bar-shaped sensor elements and arranged in parallel, respectively. The multiple touch sensor patterns 102 and 103 are configured in perpendicular from with each other to construct a double-side ITO bar type touch sensor patterns.

The thickness of the ITO layer on the substrate is preferably within a range from 50 to 300 nm. A cover portion has a touch-sensing function configured on an external side of an electronic device for providing the touch-sensing function and protecting the electronic device. In general, the ITO film obtained by doping tin to Indium oxide may be employed as an electrode material of a capacitive touch panel.

The ITO film in the amorphous state has an etching rate greater than that of a polycrystalline ITO film when etching is performed to pattern it into a desired shape, for example, by wet etching with a mixture etching solution of hydrochloric acid and nitric acid. Therefore, for example, when, as described below, the ITO film is used as a pixel electrode of a liquid crystal display device, the formed amorphous ITO film can be etched in a short time to obtain a desired pixel electrode pattern. For example, when an electrode which need not be patterned separately such as a common electrode of the liquid crystal display device, is etched by removing the periphery of the substrate, the etching can be performed in a short time by first forming the ITO film in the amorphous state as described above. Even when the etching is not required, it may be configured to form the amorphous ITO film and then to perform the thermal treatment for poly-crystallization in order to improve the film quality.

The amorphous ITO film formed at room temperature in the water added atmosphere as described above has high resistance and low light transmittance. Accordingly, it may adopt a thermal annealing treatment under conditions to treat the aforementioned amorphous ITO film so to produce the polycrystalline ITO film having low resistance and high transmittance.

A crystalline ITO layer may be formed on top of a substrate by heating ITO to a high temperature while limiting a temperature increase of the substrate to less than a predetermined temperature. For example, a layer including amorphous ITO may be deposited on top of the substrate, and a surface anneal process may be used to cause the ITO to undergo a phase conversion from amorphous ITO to crystalline ITO. The layer including amorphous ITO may be, for example, a layer including both amorphous ITO and crystalline ITO. In the surface anneal process, energy is applied in such a way that most of the energy is absorbed by the layer including amorphous ITO, and not the substrate. For example, the amorphous ITO layer may be exposed to laser light, ultraviolet (UV) radiation, microwave radiation, or other electromagnetic (EM) radiation. The wavelength of the radiation can be chosen such that the amorphous ITO layer absorbs most of the energy of the radiation. In this way, for example, the amorphous ITO layer may be sufficiently heated to undergo the phase conversion to crystalline ITO while the temperature increase of the substrate can be limited, since most of the energy is absorbed by the ITO layer. In another example, energy absorption can be focused on the ITO layer by applying an electrical current to the ITO layer. The electrical resistance of the ITO layer causes some of the energy of the electrical current to be absorbed by the ITO layer in the form of heat. Focusing the flow of the electrical current through the ITO layer can allow most of the energy to be absorbed by the amorphous ITO layer, thus heating the ITO to high temperature and causing phase conversion to crystalline ITO, while limiting the temperature increase of the substrate to less than a predetermined temperature.

In another example, crystalline ITO may be deposited on a bare substrate (i.e., without a layer including amorphous ITO) using a deposition process, such as physical vapor deposition (PVD), that heats ITO to high temperature (e.g., 200-350 degrees C. or higher) while limiting the temperature increase of the substrate to less than a predetermined temperature. For example, the substrate may be passed through a high-temperature ITO deposition chamber quickly, before the temperature of the substrate increases beyond a predetermined threshold temperature, to deposit a thin layer of crystalline ITO. The substrate can be passed through the chamber multiple times until the ITO layer reaches a desired thickness. Forming a crystalline ITO layer on top of a substrate while limiting a temperature increase of the substrate may be particularly useful in the production of LCD touch screens, for example, since the liquid crystal of the LCD can degrade if exposed to temperatures beyond approximately 100 degrees C. In this regard, the following example embodiments of the invention are described and illustrated herein in terms of LCD touch panel. However, it should be understood that embodiments of this invention are not so limited, but are additionally applicable to other applications in which a crystalline layer of ITO is formed on top of a temperature sensitive substrate and/or near a temperature sensitive material. It should also be noted that embodiments of this invention are also applicable to the formation of crystalline ITO on substrates in general, that is, even when there is no particular temperature sensitivity of the substrate or surrounding materials.

In another example, referring to FIG. 1B, it shows a signal-side ITO diamond type capacitive touch sensor. The capacitive touch sensor may have any suitable configuration to detect touch via capacitance change. The capacitive touch sensor includes multiple first touch sensor patterns (inductive electrode patterns) 104 and multiple second touch sensor patterns 105 regularly formed on a substrate, respectively. The multiple first touch sensor patterns 104 comprises a plurality of rows of sensor elements, and the multiple second touch sensor patterns 105 comprises a plurality of columns of sensor elements, that together form a plurality of pixels each being configured to detect touch at a location on the body over the pixel. Each sensing pixel can be associated with an area for which the sensing pixel is intended to detect touch events. The rows of sensor elements are separated from the columns of sensor elements via a dielectric layer 106. In one embodiment, each sensor element has a rectangular shape that is connected with adjacent sensor elements in the same row or column at opposite corners. However, it will be appreciated that a sensor element may have any other suitable shape than that shown. Similarly, the multiple touch sensor patterns 104 and 105 are a touch-sensing layer, which may be formed by an transparent conductive layer, such as an indium tin oxide (ITO), indium zinc oxide (IZO), or Indium Tin Zinc Oxide (ITZO) layer, and for example formed by PVD, or an inductive electrode layer to form multiple inductive electrode patterns. An exemplary thickness of the transparent conductive layer is about 50 nm. For example, in this embodiment, the multiple first and second touch sensor patterns 104, 105 are arranged in an array closely to construct a single-side ITO diamond type touch sensor patterns. Each touch sensor patterns 104, 105 is connected to a line (lead) 107 and subsequently connected to a control chip (not shown) on a control circuit board via the line 107.

An area of each of the touch sensor patterns 104, 105 is substantially equal to one another. In order to present in a concise manner, merely part of the lines 107 are shown in the drawing. The lines 107 can be made of metal material or indium tin oxide (ITO). One end of the line 107 is connected to the first and second touch sensor pattern 104, 105 and the other end of the line 107 is connected to a connector 108, wherein the connector 108 is coupled to the control chip on the control circuit board which can be made of flexible printed circuit (FPC) or printed circuit board (PCB).

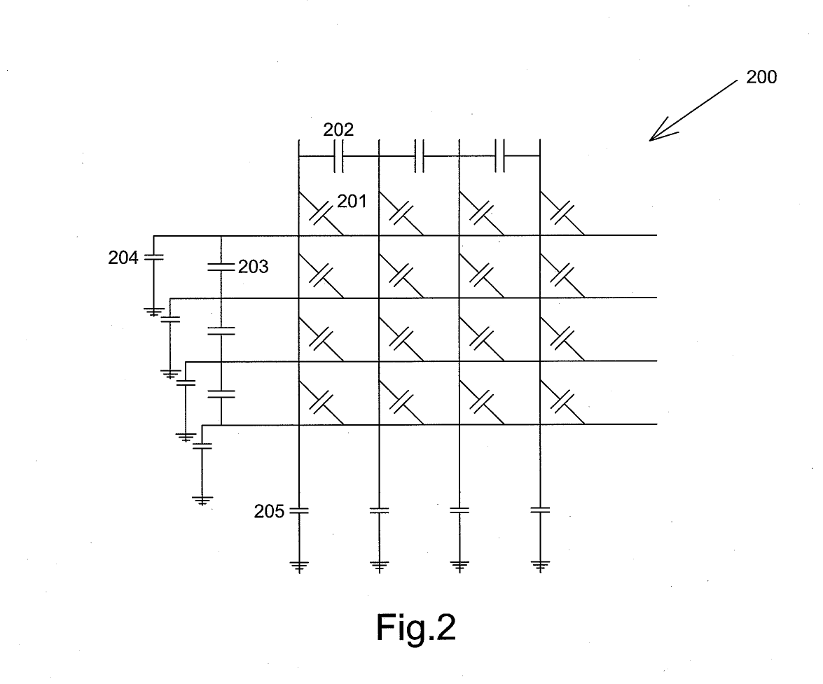

Considering the sensing speed and the identification of touching locations, the matrix type is commonly used for its effectiveness. Referring to FIG. 2, the capacitance scheme of matrix electrodes is illustrated. The matrix electrodes 200 are scanned adjacently or by the cross nodes to discover if any touch signal is on the touch sensor. Any suitable sensor size and number of sensor elements may be used. For example, in some embodiments, a sensor area of approximately 100 mm.times.50 mm may be used. In one embodiment, such touch sensor having m×n sensor elements may have a number of columns and rows equal to (m+n), and (m+n) capacitance measurements yield a full readout of the sensor. However, in this embodiment, if a user is touching multiple rows and/or multiple columns at one time, some ambiguity may exist about the location of the touch. As illustrated in FIG. 2, this ambiguity may be overcome to some degree by the use of multiple capacitances 204 and 205 to ground in each row and/or each column of the sensor elements. Furthermore, the periphery of the touch sensor is configured by multiple auxiliary capacitances 202 and 203 in each row and/or each column of the sensor elements. If the capacitance 201 from one sensor element to another sensor element is touched, then m×n measurements may be made, as the capacitance 201 may be measured from each row to each column. In this case, it is possible to resolve each touch location independently where a touch occurs over multiple columns and/or multiple rows.

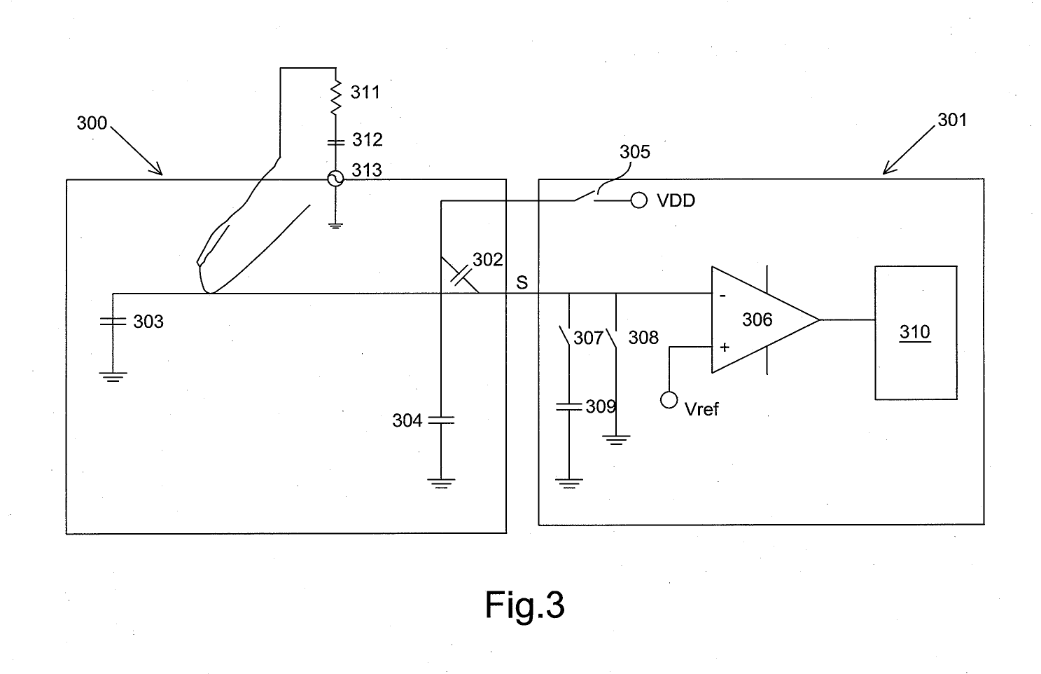

Referring to FIG. 3, it shows the simplified electrodes sensing model. In this example, the electrodes 300 are connected to the sensing circuit 301 during the scanning by using the charge-transfer method. In the electrode 300, the capacitances 303, 304 are grounded in the sensor element. The capacitance 303 is mounted on a path S (sense line). The capacitance 304 is located on a vertical line. The capacitance 302 is a sensing capacitance, coupled to the path S and the vertical line. One terminal of the sensing capacitance 302 is connected to a switch 305 of the sensing circuit 301 via the vertical line. The input path S is applied on an input (negative terminal) of a comparator or amplifier circuit 306. The positive terminal of the comparator 306 is coupled to a stored preset reference voltage (Vref). The third terminal of the comparator 306 is coupled to a control circuit 310. This sensing circuit 301 thus comprises switches 305, 307, 308, a comparator or amplifier circuit 306, and a control circuit (unit) 310. The control circuit 310 may be used for applying a digital command for switching the switches 307, 308. One terminal of the switches 307, 308 is mounted in parallel on the path S, another terminal of the switches 307, 308 is coupled to a capacitance 309 and grounded, respectively. Then, the capacitance 309 is a reference capacitance which is grounded. The comparator 306 may be performed a comparison between VDD and the stored preset reference voltage (Vref). Such the sensing circuit 301 thus performs the conversion of a value of the capacitance 302 present on the path S into an indication of the digital value corresponding to said value of the capacitance 302 seen by the input path S. When there is no finger touch, the sensing capacitance 302 is only the capacitance from the electrode scheme viewed from the sensing circuit 310. When the finger is touching, the capacitance viewed from the sensing circuit 310 becomes the sensing capacitance 302 plus an induced capacitance 312 by the finger. The finger with an intrinsic resistance 311 may produce a noise signal 313 when touch the electrode 300.

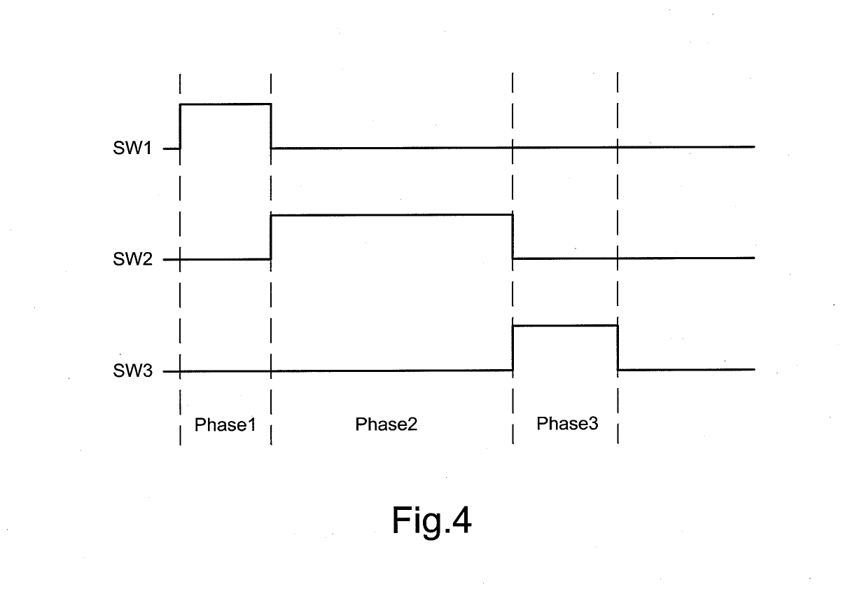

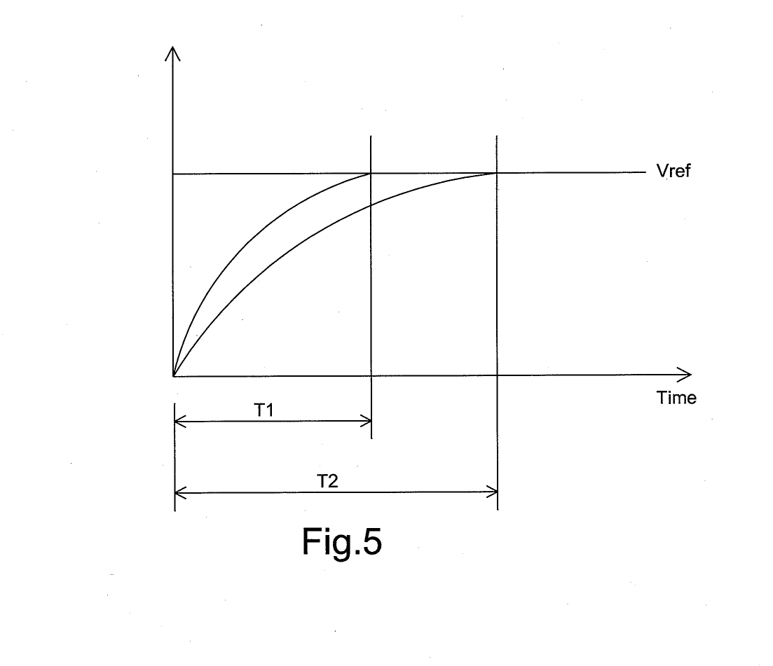

The sensing method of the electrodes sensing model is explicitly explained from the following timing diagram, shown in FIG. 4. The sensing process may be included three phases. In phase 1, the switch 305 (SW1) is close, the switch 307 (SW2) is open, and the switch 308 (SW3) is open. Meanwhile, the sensing circuit 301 sends the VDD to the sensor electrode 300 as the charging process. In phase 2, the switch 305 (SW1) is open, the switch 307 (SW2) is close, and the switch 308 (SW3) is open. Then, the accumulated charge on the sensor electrode 300 is transferred to the internal capacitor for the measurement. In phase 3, the switch 305 (SW1) is open, the switch 307 (SW2) is open, and the switch 308 (SW3) is open. Accordingly, the charge is released from the internal capacitor and prepared for the next charge to the sensor electrode 300. In the phase 2, the charged electrode transfers the capacitance into the voltage for the measurements. When the finger is touching, the total capacitance is the sensing capacitance 302 plus the induced capacitance 312, which is larger than that of the sensing capacitance 302 without the finger touch. The transferred voltage is compared to the pre-stored reference voltage (Vref). It takes longer to reach the Vref when the total capacitance is larger. Therefore, a finger touch can be identified if the charge time is more than a defined period. In FIG. 5, the T2 could be recognized as the time of the finger touch in the charge-transfer process. T1 is the time in the charging process without finger touch. FIG. 5 shows a charge time with different capacitances.

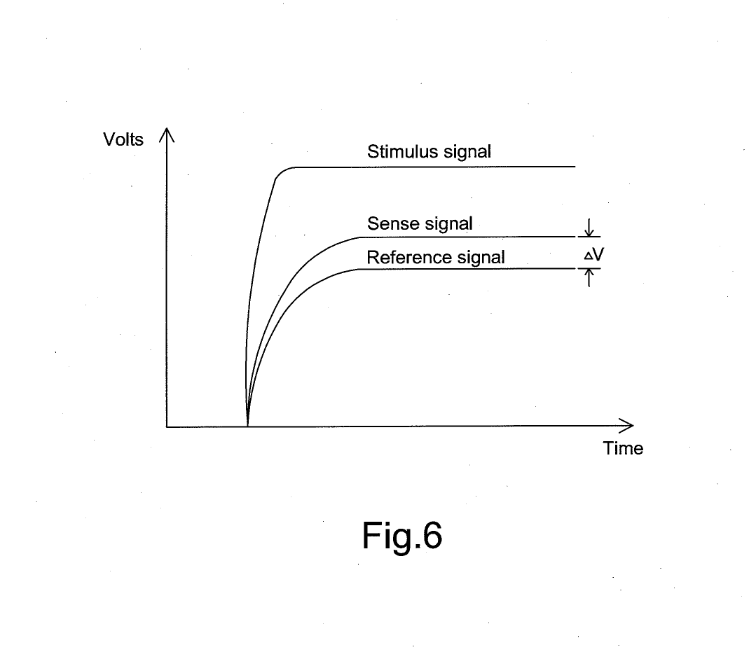

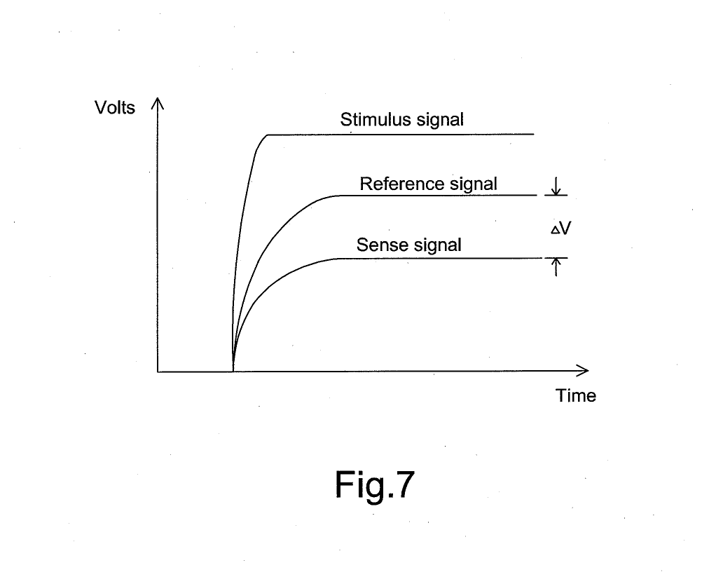

In simplified circuit, the touch sensor has an array of the sensor elements to yield a full readout of the sensor. On one dimension (column or row), one electrode is defined as the sense electrode where the finger is touched, and the adjacent electrode is defined as the reference electrode with the driving signal from the electrode on the other dimension (column or row). A sense signal may be produced by the sense electrode, and a reference signal may be created by the reference electrode. FIG. 6 shows the sense signal and the reference signal after stimulating. Due to the variations of the sense electrode (such as ITO electrode) manufacture process, the traces between the sensing circuit (sensor IC) and the sense electrode (ITO sensor), the internal IC manufacture process and the external environment, there is a balance circuit to compensate the offset with the internal capacitors for the variation on the inputs to the comparator. The ΔV is considered as the offset (ΔV_{offset}) which represents the combined intrinsic characteristic from the variations above, shown in FIG. 6. When the sense line is touched with the finger, the unbalance offset between the sense line and the reference line is increased as shown in FIG. 7. FIG. 7 shows the sense signal and the reference signal after touching under stimulus, wherein the ΔV is considered as the (ΔV_{offset}+ΔV_{finger}) larger than the offset (ΔV_{offset}).

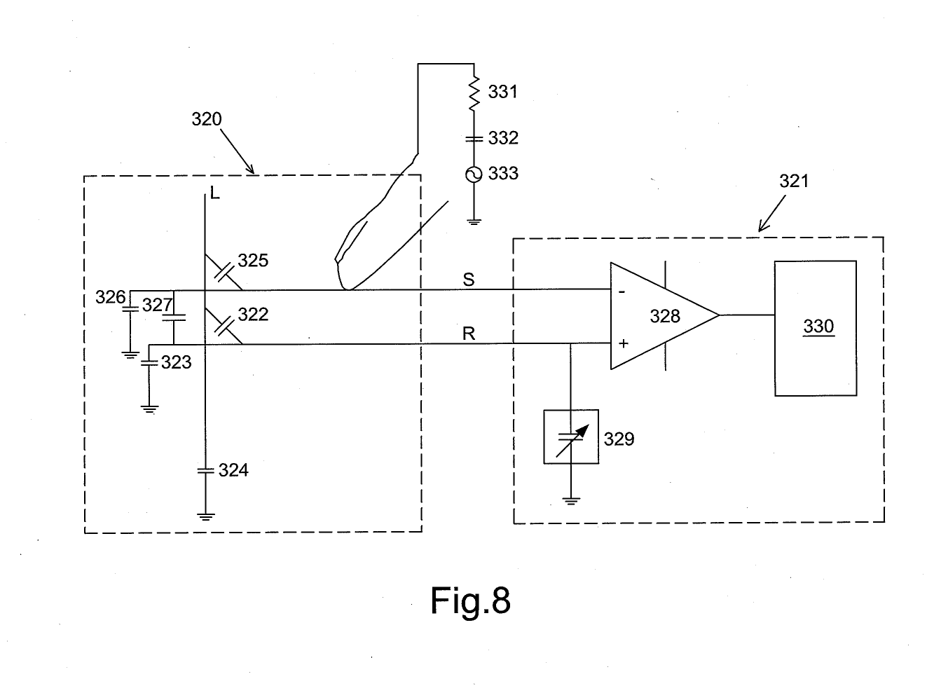

To detect such touch signal, a quantifying circuit is used to calculate the charged ΔV and the respective ΔV_{finger}. This surely increases the cost of the sensor circuit (IC). The noise information from the external environment could not be handled without looping the 2^{nd} matrix scan. Thus, another electrode sensing scheme is provided for the present invention, which the same electrode matrix scheme is used for connecting to the simplified sensing circuit and the control circuit (unit), as shown in FIG. 8.

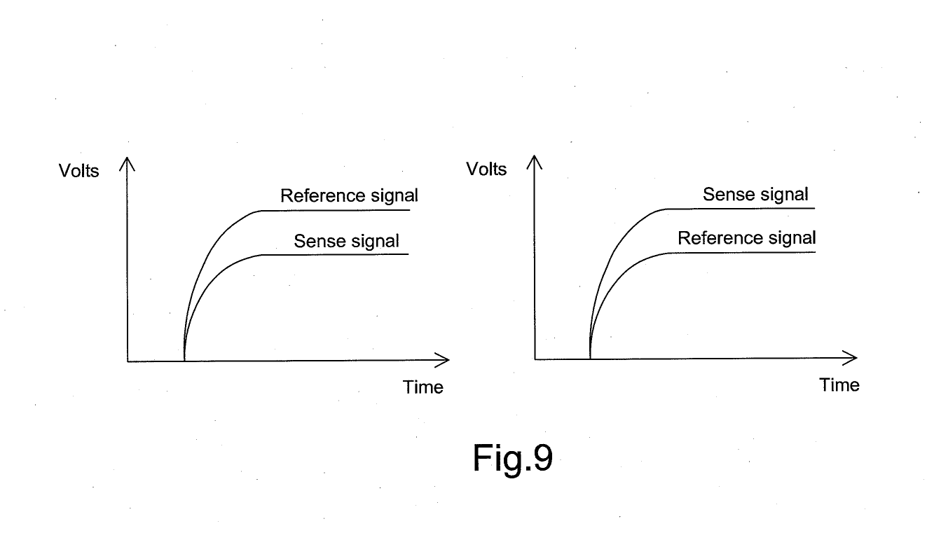

Referring to FIG. 8, it shows an electrode sensing scheme according to one embodiment of the present invention. In this example, the electrodes 320 are connected to the sensing circuit 321 during the scanning by using the charge-transfer method. In the electrode 320, the capacitances 326, 323 are grounded in the sensor element. The capacitance 326 is mounted on a path S (sense line) of detection. The capacitance 326 is mounted on a path R (sense line) of reference. The capacitance 327 is located between the sense path S and the reference path R. The capacitance 325 is a sensing capacitance, coupled to the path S and a vertical line L. The capacitance 322 is a reference capacitance, coupled to the path S and the vertical line L. A capacitance 324 is under the reference path R and grounded in the vertical line. The input of the path S is applied on an input (negative terminal) of a comparator or amplifier circuit 328, and the input of the path R is applied on another input (positive terminal) of the comparator or amplifier circuit 328. Moreover, the positive terminal of the comparator 328 is also coupled to a variable capacitor 329. The third terminal of the comparator 328 is coupled to a control circuit 330. In this scheme, this sensing circuit 321 comprises the comparator or amplifier circuit 328, variable transfer capacitance 329 and a control circuit (unit) 330. The control circuit 330 may be used for applying a digital command for adjusting the variable transfer capacitance 329. In this embodiment, switches are not useless. The variable transfer capacitance 329 is grounded. The comparator 328 may be performed a comparison between the sense signal (on sense path R) and the reference signal (on reference path R). In the sensor circuit (IC) 321, the output from the comparator 328 is based on the electrode inputs as shown in FIG. 9. In one embodiment, after the charging has been completed for a period of time (T), in ideal condition (without the noise), the output of the comparator 328 is “1” (relative high voltage level) if the intensity of the reference signal is higher than that of the sense signal, shown in left side of FIG. 9. Again, if the intensity of the reference signal is smaller than that of the sense signal, then the output of the comparator 328 becomes “0” (relative low voltage level), shown in right side of FIG. 9. FIG. 9 depicts the behavior of the comparator 328 based on the inputs.

Due to the variation from the manufacture process and the environment conditions, the output of the comparator 328 cannot be fixed to 0 or to 1 from every electrode scan as the variation could be so small and be influenced from the environment noise or the human body noise. In order to have a consistent initial status (without finger touch) for every electrode scan, the output of the comparator 328 is fixed to either “0” or “1” state. This can be done by controlling the variable capacitor 329 which is connected to the reference line R prior to the input terminal of the comparator 328. The setting of this variable capacitor 329 is called the reference value (preset value). This reference value can be adjusted from the control circuit 330 based on the input signal noise 333. When the finger is touching, the capacitance viewed from the sensing circuit 320 becomes the sensing capacitance 332 plus an induced capacitance 325 by the finger. The finger with an intrinsic resistance 331 may produce a noise signal 333 when touch the electrode 320. In this sensing scheme, the sensor circuit (IC) 321 is simplified without the quantization circuit. The output of the quantization circuit is a digital signal.

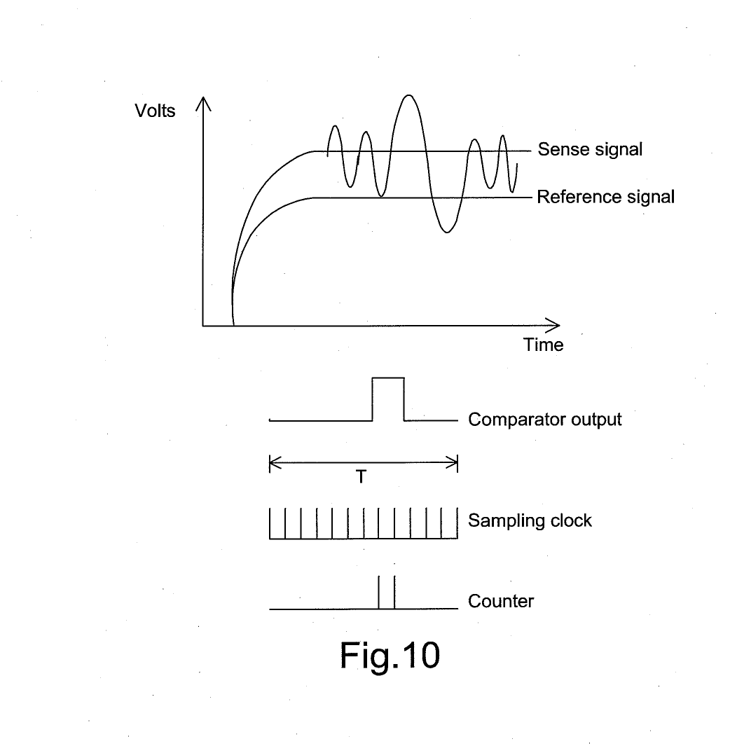

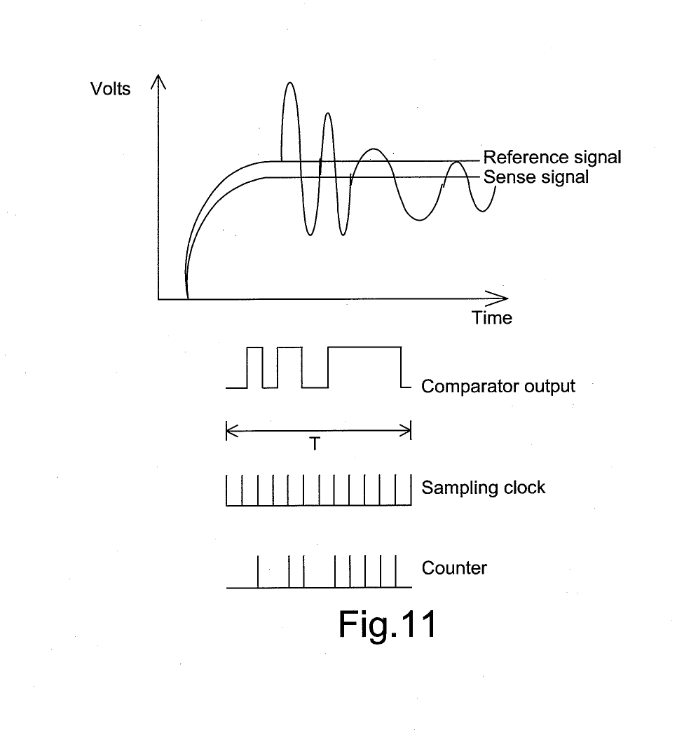

In another example, assuming the initial state of the comparator 328 is set to “0”, the intensity of the reference signal is slightly lower than that of the sense signal as shown in the right side of FIG. 9. In the real case, when the noise is incorporated into the circuit, the resulted signals from the scanning would look like in FIG. 10. FIG. 10 shows signals with incorporated noise. In the period of time (T), the output from the comparator 328 is depending on the input sense signal whether the level is higher or lower than the reference signal. This output signal of the comparator 328 is sampled by the internal clock in the control circuit 321. In this example, the output signal of the comparator 328 is single wave (pulse). In the example of FIG. 10, the counter value is 2 from the sense signal. In another condition, the finger touches the sense line, shown in the FIG. 8. As the finger touches the sense line (S), the capacitance 332 from the human body is incorporated into the system along with the noise signal. That is, the signals are finger touch incorporated noise signal, shown in FIG. 11. In the example of FIG. 11, the counter value is 8 in the period of time (T), and the output signal of the comparator 328 includes three waves (pulses). For given the conditions in FIGS. 10 and 11, the following observations or rules could be made. In the FIG. 10, the counter value is only 2 during the period of time (T), and it is considered as the environment noise, instead of the finger touch because the sense signal stays above reference signal most of time. In the FIG. 11, the counter value is 8 during the period of time (T), and it is then identified as the finger touch because the sense signal stays below reference signal most of time. It indicates that the counter value as the finger touch is larger than that as without finger touch.

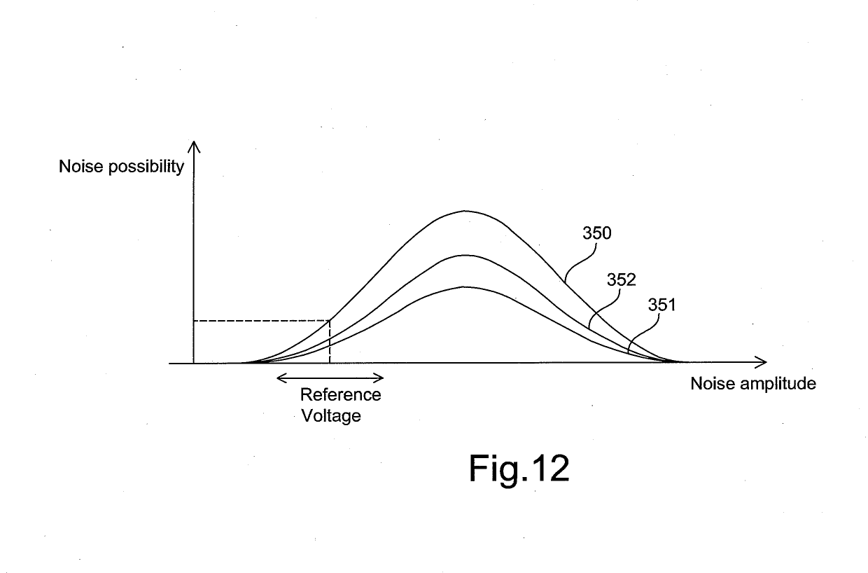

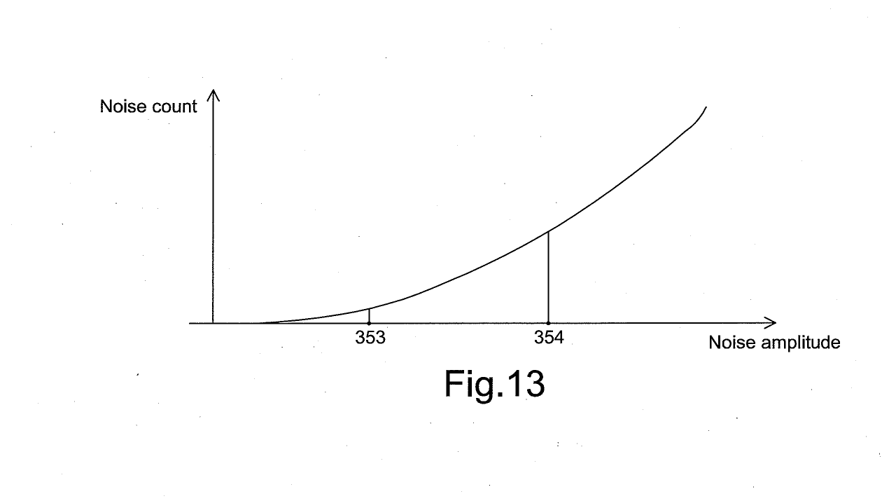

As above-mentioned, the counter value is increasing as the finger touch. Therefore, the finger touch may be recognized by the counter value. In FIG. 12, the possibility of noise is considered as the normal distribution in terms of the peak to peak noise amplitude. The curves 350, 352, 350 of the possibility of noise are determined as large capacitance, middle capacitance and small capacitance, respectively. The larger capacitance is, and the larger possibility of noise is. The noise possibility is transferred to the noise count after performing by the comparator 328 and sampling process in the control circuit 330, shown in FIG. 13. The reference value 353 is set according to the lower limit where the noise count is kept at the low value as the initial state when there is no touch. When the finger is touching, the noise level (count) is increased along with the finger signal level is increased. The noise count is set as the switching threshold value 354 for the identification of the finger touches. FIG. 13 depicts the reference value (voltage) and the switching threshold value (voltage).

A calibration process is needed by sweeping the reference level to have the following purposes; a). To set the reference level for the initial state; b).To set the threshold value for the switching counter. The counter value is based on the sampled signal level. When the counter value is high, it means the sampled signal is intensive, strong and high, and vice versa. Therefore, the circuit sensitivity for the touching signal can be adjustable when the reference level of the initial state and the switching threshold value are adjusted.

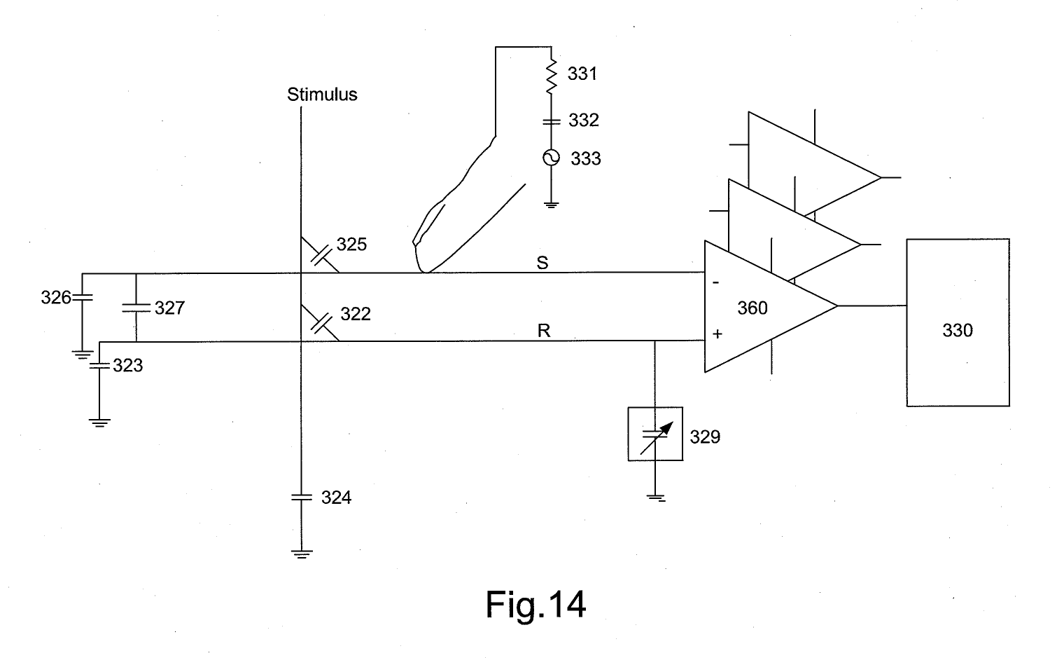

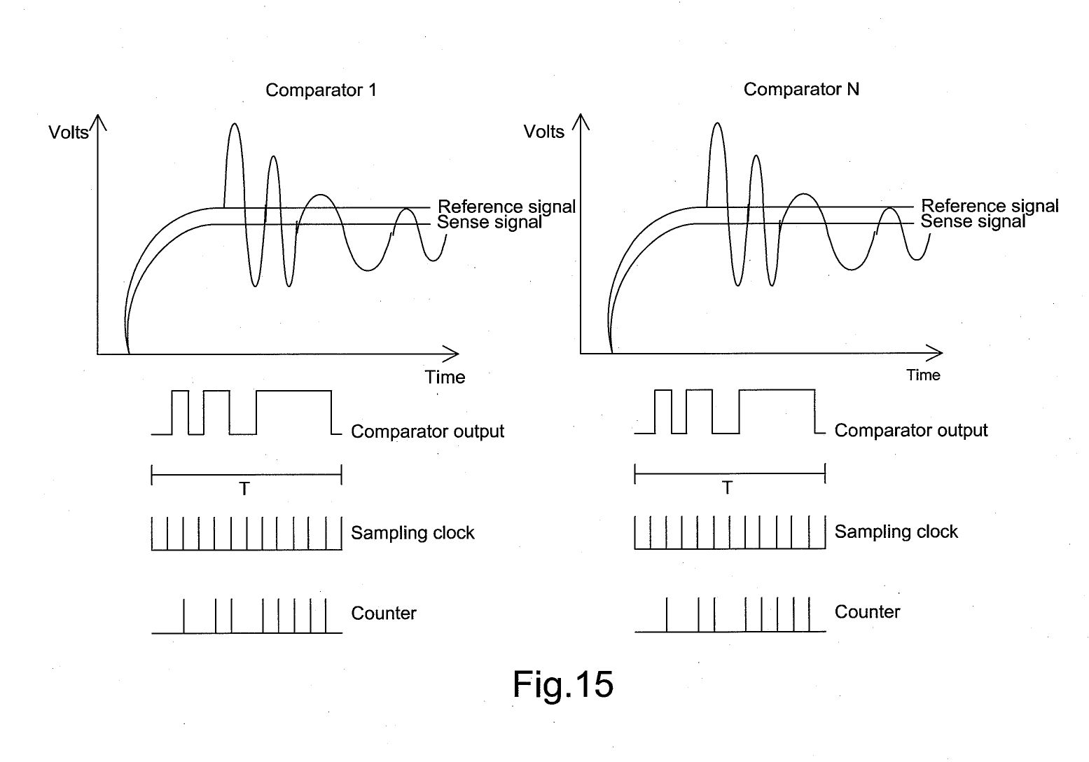

Based-on another aspect, the global noise filter can be done by using a group of comparators 360 to detect the sense signals at the same time, as shown in FIG. 14. FIG. 14 shows a group sensing scheme. The number of the comparators 360 and the related circuits are depending on the actual hardware implementation. The idea here is to implement the global noise filter by identifying the same or similar noise pattern on the several sensing circuits when they are sensing the touch signals at the same time. Take one finger touch on one electrode as an example, suppose only one sense line (S) is sensed with finger signal and the sensed comparator is switched to another direction. From a group sensing, if all comparators 360 show the same behavior, e.g. switching to another direction, with a great chance, the changes may be from the impact of the global noise, instead of the single finger signal. FIG. 15 shows a noise impact from the group sensing, wherein comparator 1 and comparator N have the same behavior and noise pattern.

From the practical world, the noise over the signal is the natural characteristics in the electrical circuit. By handling this characteristic, the following targets including sensing circuit, adjustable sensitivity and global noise filtering, are meant to be realized on the capacitive touch panel as illustrated in the above-mentioned.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention. While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A capacitive touch panel, comprising:
a comparator receiving a sense signal of a sense path and a reference signal of a reference path at a first input and a second input of said comparator, respectively;
a transparent electrode coupled to said sense path and said reference path;
a variable transfer capacitance connected to said first input or said second input of said comparator; and
a control unit connected to an output of said comparator.

2. The capacitive touch panel of claim 1, wherein said variable transfer capacitance is controlled by a digital command produced by said control unit.

3. The capacitive touch panel of claim 1, wherein said output from said comparator is based on inputs of said transparent electrode.

4. The capacitive touch panel of claim 1, wherein a first output of said comparator is 1 if said reference signal through said reference path is higher than that of said sense signal through said sense path.

5. The capacitive touch panel of claim 1, wherein a second output of said comparator is 0 if said reference signal is smaller than that of said sense signal.

6. The capacitive touch panel of claim 1, wherein a noise possibility is transferred to a noise count after performing a sampling process when touching said sense path.

7. The capacitive touch panel of claim 6, wherein said noise count is set as a switching threshold value for an identification of said touching, and a circuit sensitivity for said touching can be adjusted when a reference level without touching and said switching threshold value are adjusted.

8. The capacitive touch panel of claim 1, further comprising a plurality of comparators to detect sense signals of said sense path at the same time.

9. A touch-sensing circuit, comprising:
a comparator receiving a sense signal of a sense path and a reference signal of a reference path at a first input and a second input of said comparator, respectively;
a transparent electrode coupled to said sense path and said reference path;
a variable transfer capacitance connected to said first input or said second input of said comparator; and
a control unit connected to an output of said comparator.

10. The touch-sensing circuit of claim 9, wherein said output from said comparator is based on inputs of said transparent electrode.

11. The touch-sensing circuit of claim 9, wherein a first output of said comparator is 1 if said reference signal through said reference path is higher than that of said sense signal through said sense path, and a second output of said comparator is 0 if said reference signal is smaller than that of said sense signal.

12. The touch-sensing circuit of claim 9, wherein a noise possibility is transferred to a noise count after performing a sampling process when touching said sense path, wherein said noise count is set as a switching threshold value for an identification of said touching, and a circuit sensitivity for said touching can be adjusted when a reference level without touching and said switching threshold value are adjusted.

13. A sensing method for a capacitive touch panel, comprising:
receiving a sense signal of a sense path and a reference signal of a reference path;
setting an intensity of said reference signal lower than that of said sense signal at an initial state;
outputting a relative high voltage level if said reference signal is higher than that of said sense signal;
determining a counting value in a period of time from said sense signal; and
determining an intensity of said sense signal based on said counting value.

14. The method of claim 13, wherein said counting value is outputted by a comparator.

15. The method of claim 14, wherein an output signal of said comparator is sampled by an internal clock in a control circuit.

16. The method of claim 14, wherein a first output of said comparator is 1 if said reference signal through said reference path is higher than that of said sense signal through said sense path.

17. The method of claim 14, wherein a second output of said comparator is 0 if said reference signal is smaller than that of said sense signal.

18. The method of claim 13, wherein a noise possibility is transferred to a noise count after performing a sampling process.

19. The method of claim 18, wherein said noise count is set as a switching threshold value for an identification of a touching signal, and a circuit sensitivity for said touching signal can be adjusted when a reference level without touching and said switching threshold value are adjusted.

20. The method of claim 13, further comprising providing a plurality of comparators to detect sense signal of said sense path at the same time.
